(19) United States
(12) Patent Application Publication
(10) Pub. No.: US 2013/0157039 A1
(43) Pub. Date: Jun. 20, 2013

(54) STRUCTURAL MEMBERS INCLUDING SHAPE MEMORY ALLOYS

(71) Applicant: GM GLOBAL TECHNOLOGY OPERATIONS LLC, Detroit, MI (US)

(72) Inventors: Alan L. Browne, Grosse Pointe, MI (US); Nancy L. Johnson, Northville, MI (US); Peter Maxwell Sarosi, Ferndale, MI (US); John C. Ulicny, Oxford, MI (US)

(73) Assignee: GM GLOBAL TECHNOLOGY OPERATIONS LLC, Detroit, MI (US)

(21) Appl. No.: 13/686,849

(22) Filed: Nov. 27, 2012

Related U.S. Application Data
(60) Provisional application No. 61/576,123, filed on Dec. 15, 2011.

(51) Int. Cl. E04B 1/82; B32B 5/00; B32B 7/12; B32B 3/26

(52) U.S. Cl. CPC E04B 1/82; B32B 3/26; B32B 5/00; B32B 7/12
USPC 428/313.9; 428/457; 252/62

(57) ABSTRACT

Structural members are disclosed herein. One example of the structural member includes a composite structure and a filler incorporated therein. The filler at least dampens any of sound wave propagation through the composite structure or vibration of the composite structure. The filler includes particles of a shape memory alloy having an Austenite finish temperature (A_{f}) that is lower than a temperature encountered in an application in which the structural member is used so that the shape memory alloy exhibits stress-induced superelasticity. Also disclosed herein are other examples of structural members.

### CROSS-REFERENCE TO RELATED APPLICATIONS

This application claims the benefit of U.S. Provisional Application Ser. No. 61/576,123, filed Dec. 15, 2011.

### TECHNICAL FIELD

The present disclosure relates generally to structural members including shape memory alloys.

### BACKGROUND

Structural members are often used in the automotive industry, e.g., for various automotive body parts, structural panels, and/or the like.

### SUMMARY

A structural member includes a composite structure and a filler at least to dampen sound wave propagation through and/or vibration of the composite structure. The filler is incorporated into the composite structure, and are particles of a shape memory alloy having an Austenite finish temperature (A_{f}) that is lower than a temperature encountered in an application in which the structural member is used so that the shape memory alloy exhibits stress-induced superelasticity.

Also disclosed herein are other examples of the structural member.

### BRIEF DESCRIPTION OF THE DRAWING

Features and advantages of examples of the present disclosure will become apparent by reference to the following detailed description and the drawings, in which like reference numerals correspond to similar, though perhaps not identical, components. For the sake of brevity, reference numerals or features having a previously described function may or may not be described in connection with other drawings in which they appear.

FIG. 1 is a stress and temperature based phase diagram for a shape memory alloy; and

FIGS. 2-4 are cross-sectional, schematic depictions of examples of different structural members.

### DETAILED DESCRIPTION

Example(s) of the structural member as disclosed herein may be used in the automotive industry, e.g., for automotive panel structures, automotive body structures, and/or the like. It is envisioned that the structural members may also be useful for other technologies not related to the automotive industry, examples of which include the construction industry and the aerospace industry.

One example of the structural member generally includes a composite structure having a filler incorporated therein. The filler includes a shape memory alloy (SMA) that exhibits stress-induced superelasticity (discussed further below). The filler may be present in any suitable amount. As an example, the amount of filler ranges from 5 vol. % to greater than 50 vol. % of the structural member. In another example, the amount of filler in the structural member may range from about 10 vol. % to about 30 vol. %.

Another example of the structural member includes two structures (none or one or both of which may be a composite material) having a joint formed between them. The joint includes an adhesive and an SMA distributed throughout the adhesive that exhibits stress-induced superelasticity. The SMA may be present in the adhesive in any suitable amount. As an example, the amount of SMA ranges from 5 vol. % to greater than 50 vol. % of the adhesive. In another example, the amount of SMA in the adhesive may range from about 10 vol. % to about 30 vol. %.

Still another example of the structural member includes two structures (none or one or both of which may be a composite material) having an SMA disposed in a carrier and between the members. Again, the SMA exhibits stress-induced superelasticity. The SMA may be present in the carrier in any suitable amount. As an example, the amount of SMA ranges from 5 vol. % to greater than 50 vol. % of the carrier. In another example, the amount of SMA in the carrier may range from about 10 vol. % to about 30 vol. %.

For purposes of the instant disclosure, the SMA incorporated as the filler, incorporated into the adhesive at the joint, or disposed between the two structures is referred to herein as a superelastic shape memory alloy (or superelastic SMA).

It is known that superelastic SMAs, while in the superelastic state, are highly deformable, and exhibit shape memory characteristics; i.e., they have the ability to recover their original geometry after the deformation when subjected to an appropriate stimulus (i.e., when stress that causes the deformation is removed). It is believed that the use of the SMA in the examples of the structural member produces structural members that, for example, tend to exhibit high wear resistance, high strength, high cycle fatigue life, high fracture toughness, and high mechanical hysteresis (i.e., will be effective in damping vibrations and reducing sound transmission/propagation).

It is further believed that the use of the superelastic SMA in the structural member will, in examples where the SMA particles have a hollow geometric form, reduce the overall weight of the member and may also enhance the structural life of the members, e.g., in response to a physical impact. For instance, while exhibiting stress-induced superelasticity (which will be described in further detail below), the SMA enhances energy absorption (e.g., by the flexibility of the hollow SMA particles) when the member is exposed to some type of physical impact. The enhancement in energy absorption may thus increase a crush efficiency of the member, which may in turn increase the member's elastic limit and ultimate strain (i.e., the strain that the member may be subjected to before the strain overcomes the structural integrity of the member). In this way, the member including the superelastic SMA may be able to dissipate and absorb energy associated with higher energy impacts than those members that do not include the superelastic SMAs (especially when the SMAs are in the form of hollow particles).

It is generally known that SMAs are a group of metallic materials that are able to return to a defined shape, size, etc. when exposed to a suitable stimulus. SMAs undergo phase transitions in which yield strength (i.e., stress at which a material exhibits a specified deviation from proportionality of stress and strain), stiffness, dimension, and/or shape are altered as a function of temperature. In the low temperature or Martensite phase, the SMA is in a deformable phase, and in the high temperature of Austenite phase, the SMA returns to the remembered shape (i.e., prior to deformation). SMAs are also stress-induced SMAs (i.e., superelastic SMAs), which will be described further hereinbelow.

When the shape memory alloy is in the Martensite phase and is heated, it begins to change into the Austenite phase. The Austenite start temperature (Aₛ) is the temperature at which this phenomenon starts, and the Austenite finish temperature (A_{f}) is the temperature at which this phenomenon is complete. When the shape memory alloy is in the Austenite phase and is cooled, it begins to change into the Martensite phase. The Martensite start temperature (Mₛ) is the temperature at which this phenomenon starts, and the Martensite finish temperature (M_{f}) is the temperature at which this phenomenon finishes.

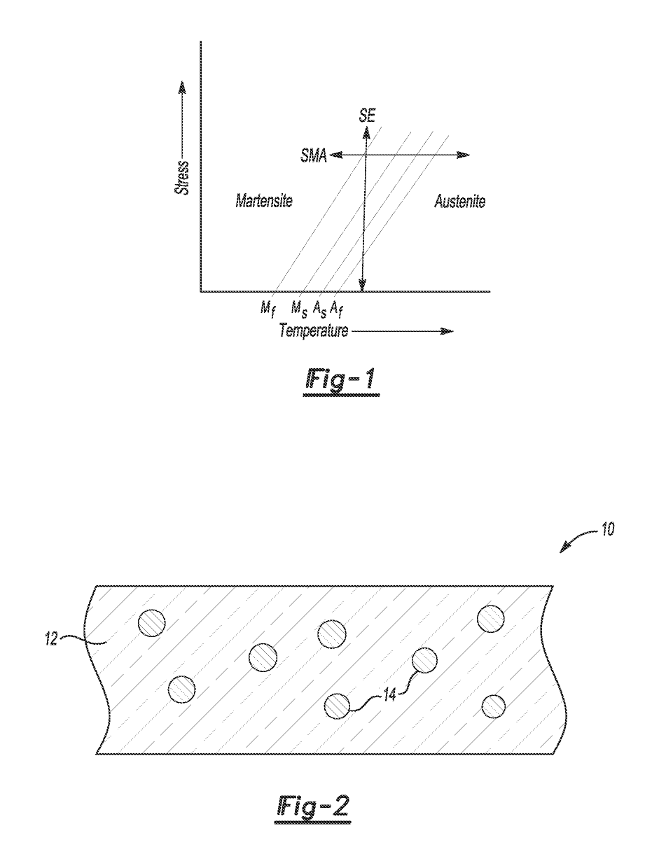

FIG. 1 illustrates a stress and temperature based phase diagram for a shape memory alloy. The SMA horizontal line represents the temperature based phase transition between the Martensitic and Austenitic states at an arbitrarily selected level of stress. In other words, this line illustrates the temperature based shape memory effect previously described herein.

Superelasticity (SE) occurs when the SMA is mechanically deformed at a temperature that is above the A_{f} of the SMA. In an example, the SMA is superelastic from the A_{f} of the SMA to about A_{f} plus 50° C. The SMA material formulation may thus be selected so that the range in which the SMA is superelastic spans a major portion of a temperature range of interest for an application in which the structural member will be used. As an example, it may be desirable to select an SMA having an A_{f} of 0° C. so that the superelasticity of the material is exhibited at temperatures ranging from 0° C. to about 50° C.

This type of deformation (i.e., mechanical deformation at a temperature that is above the A_{f} of the SMA) causes a stress-induced phase transformation from the Austenite phase to the Martensite phase. Application of sufficient stress when an SMA is in its Austenite phase will cause the SMA to change to its lower modulus Martensite phase in which the SMA can exhibit up to 8% of “superelastic” deformation (i.e., recoverable strains on the order of up to 8% are attainable). The stress-induced Martensite phase is unstable at temperatures above the A_{f}, so that removal of the applied stress will cause the SMA to switch back to its Austenite phase. The application of an externally applied stress causes the Martensite phase to form at temperatures higher than the Martensite start temperature associated with a zero stress state (see FIG. 1). As such, the Martensite start temperature (M_{S}) is a function of the stress that is applied. Superelastic SMAs are able to be strained several times more than ordinary metal alloys without being plastically deformed. However, this characteristic is observed over the specific temperature range of A_{f} to A_{f} plus 50° C., and the largest ability to recover occurs within this range.

The temperature at which the SMA remembers its high temperature form may be altered, for example, by changing the composition of the alloy and through heat treatment. The composition of an SMA may be controlled to provide an A_{f} that is below the operating temperature of the automobile within which the structural member is being used, so that the SMA will behave superelastically when sufficient stress is applied. In an example, the A_{f} is selected to be within about 5° C. below the operating temperature of the automobile within which the structural member is being used.

The mechanism for damping vibrations involves a hysteresis loop. In plots of stress versus strain, any cyclic variation in stress creates a loop on the plot. The area of that loop is equal to the mechanical energy dissipated as heat. It has been found that during superelastic deformation, internal interfaces between the Austenite and Martensite phases dissipate a substantial amount of available mechanical energy during their formation and motion. It is believed that the dissipation of mechanical energy may impart some mechanical damping characteristics to the superelastic SMA. It is believed that superelastic SMAs may advantageously be incorporated into automotive structural members for damping of sound wave propagation and/or vibrations, due, at least in part, to the presence of these damping characteristics. In an example, it is believed that the SMA may dampen both low and high frequencies, such as from about 1 Hz to about 200 Hz for road-induced vibrations and from about 20 Hz to about 20,000 Hz for acoustic frequencies. Dampening may be achieved across such wide ranges, for example, when a plurality of superelastic SMA particles having a size distribution is utilized (i.e., larger particles and smaller particles) and/or when a plurality of hollow superelastic SMA particles having a wall thickness distribution is utilized (i.e., hollow particles having thinner walls and hollow particles having thicker walls).

As mentioned above, examples of the SMA that may be used in the structural members of the instant disclosure include those that exhibit stress-induced superelasticity when at temperatures greater than the Austenite finish temperature (A_{f}) of the particular SMA. Some examples of the superelastic SMA that may be used herein include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. Some specific examples include alloys of copper-zinc-aluminum-nickel, copper-aluminum-nickel, nickel-titanium, zinc-copper-gold-iron, gold-cadmium, iron-platinum, titanium-niobium, gold-copper-zinc, iron-manganese, zirconium-cobalt, zinc-copper, and titanium-vanadium-palladium. Examples of nickel-titanium based alloys include alloys of nickel and titanium, alloys of nickel, titanium, and platinum, alloys of nickel, titanium, and palladium, or other alloys of nickel, titanium and at least one other metal.

Further, the superelastic SMA may be used in the form of hollow particles, solid particles, or combinations thereof. As hollow particles, the superelastic SMA may take the form of hollow spheres having complete or incomplete shells. The SMA may also take the form of thin-walled structures that are either partially or fully filled with an elastic media. The elastic media may have a density and stiffness that are less than or equal to that of the SMA. The superelastic SMA may, in yet another example, take the form of hollow particles having other shapes (e.g., imperfect hollow spheres, hollow prisms, hollow pyramids, hollow cylinders, etc.). In some cases, the hollow particles have random shapes (e.g., some particles are spheres, some are cylinders, etc.). It is believed that hollow particles may impart less weight to the structural members, due to the lower net density of the individual SMA particles.

While the desirable wall thickness of the hollow superelastic SMA particles may vary depending upon the application in which the structural member is used, as an example, the wall thickness may range from about 5% of the radius of the particle to less than 100% of the radius of the particle. When the wall thickness exceeds 20% of the radius, the particles tend to exhibit more stiffness. As such, the wall thickness may be varied depending upon a desirable stiffness of the hollow superelastic SMA particles.

As solid particles, the superelastic SMA may also take the form of a sphere (i.e., a solid sphere as opposed to a hollow sphere), or may take the form of another shape (e.g., solid imperfect spheres, solid prisms, solid cylinders, etc.). One example of solid particles for the superelastic SMA includes chopped wire segments. Further, the solid particles may have random shapes similar to those mentioned above for the hollow particles.

Whether solid particles, hollow particles, or combinations thereof are utilized, it is to be understood that the size of the particles used may be relatively consistent or may vary (i.e., a distribution of particle sizes is included). The particles disclosed herein (whether solid and/or hollow) may have a size ranging from about 20 μm to about 2 mm.

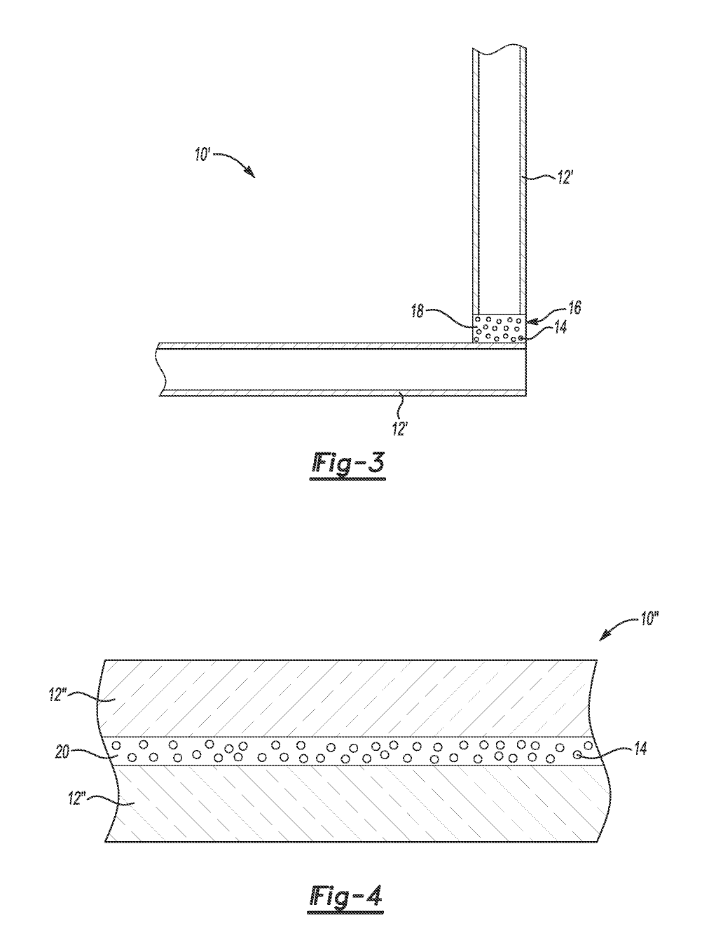

Examples of solid particles 14 are schematically shown in FIG. 2, while examples of hollow particles 14 are schematically shown in FIGS. 3 and 4.

One example of a structural member 10 is schematically depicted in FIG. 2. The member 10 includes a composite structure 12 having a filler incorporated therein. The filler, which is incorporated into the polymer matrix of the composite structure 12, consists of particles 14 of a superelastic SMA. The particles 14 of the SMA may be chosen from any of the examples of the superelastic SMA set forth above. Example amounts of the filler are provided above.

The composite structure 12 may be chosen from any suitable polymer, such as thermoplastic materials, thermoset materials, toughening agents (i.e., a polymer resin having a curing additive and/or a fracture/crack resistance additive therein), or combinations thereof.

Suitable polymers for the polymer matrix of the composite structure 12 include, for example, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate), and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsesquioxane), polyvinylchloride, urethane/butadiene copolymers, polyurethane block copolymers, styrene-butadiene-styrene block copolymers, and the like.

In an example, the structural member 10 shown in FIG. 1 is formed by adding the SMA particles 14 to the liquid resin (i.e., monomer or polymer matrix) before the resin is cured/polymerized to form the composite structure 12.

Another example of the structural member 10′ is schematically shown in FIG. 3. In this example, the member 10′ includes two structures (both identified by 12′), and a joint 16 formed between the structures 12′. It is to be understood that the size of the joint 16 shown in FIG. 3 is exaggerated in size for purposes of illustration. The joint 16 includes an adhesive 18 and particles 14 of a superelastic SMA incorporated in the adhesive 18. The adhesive 18 may be used, when applied to the structures 12′, to join to the two composite structures 12′ together.

The particles 14 of the SMA may be chosen from any of the examples of the superelastic SMA set forth above, and the structures 12′ may be formed from any of the example materials of the composite structure 12 also set forth above. In some examples, one or both of the structures 12′ may not be composite structures. Examples of non-composite structures include those made from steel, aluminum, magnesium, glass, ceramics, some plastics, and combinations thereof. Example amounts of the particles 14 that may be used in the adhesive 18 are provided above.

The adhesive 18 may be formed from an adhesive material such as an epoxy, urethane, acrylic, etc. One-part or two-part thermosets may also be suitable, as well as hot melt thermoplastics. It is to be understood, however, that any suitable adhesive may be used so long as the particles 14 of the SMA may be incorporated therein. Further, the selection of a suitable adhesive 18 may depend on the material selected for structures 12′, the cost of the adhesive 18, manufacturing constraints of processing the adhesive 18, the intended use of the structural member 10′, etc. The adhesive 18 may be cured by heat, room-temperature chemical reaction, induction, or any other curing method that is performed at a temperature sufficiently low so as to not untrain the SMA which would cause a loss in its shape memory. This sufficiently low temperature may range anywhere from about 100° C. to about 300° C. above A_{f}, depending on the particular SMA that is used.

The structural member 10′ may be made, for example, by initially making the adhesive 18 and then applying the adhesive 18 to the surface of one or both of the structures 12′ at an area of the surface(s) at which the structures 12′ are to be joined. The adhesive 18 may be made, e.g., by adding the SMA particles 14 to the adhesive material. It is to be understood that the SMA particles 14 may be added to the adhesive material at any time before the adhesive is cured. In one example, the adhesive material and the SMA particles 14 are blended together to form a substantially homogeneous (as observed by the human eye) mixture. Details of the mixing process will depend, at least in part, upon the particular characteristics of the adhesive material that is selected. Then, the adhesive 18 is applied. The adhesive 18 may be applied, e.g., as a tape, liquid, paste or pressure sensitive adhesive to the structure(s) 12′. In some instances, the applied adhesive 18 will be cured. In other instances (e.g., when the adhesive 18 is a pressure sensitive tape), curing is not utilized after the tape is applied.

Another example of the structural member 10″ is schematically depicted in FIG. 4. The example shown in FIG. 4 is similar to that shown in FIG. 3, except that FIG. 3 illustrates the particles 14 at a joint 16 and FIG. 4 illustrates the particles 14 between two components of a part, e.g., an automotive panel. As illustrated, the particles 14 are integrated within the structural member 10″. In the example of FIG. 4, the structural member 10″ includes two structures 12″ having particles 14 of a superelastic SMA disposed between them. In this example, the particles 14 are dispersed within a suitable carrier 20. The carrier 20 may be any of the previously described liquid components used to form the adhesive 18. Any of the examples of the SMA 14 and the structures 12′ mentioned above may be used for the structural member 10″. Example amounts of the particles 14 that may be used in the carrier 20 are provided above.

In this example, the carrier 20 having the particles 14 dispersed therein may be introduced between the structures 12″ via autoclaving, vacuum bagging, resin infusion molding, etc.

It is to be understood that the ranges provided herein include the stated range and any value or sub-range within the stated range. For example, a range from about 100° C. to about 300° C. above A_{f} should be interpreted to include not only the explicitly recited limits of about 100° C. to about 300° C. above A_{f}, but also to include individual values, such as 105° C., 150° C., 175° C., 200° C. above A_{f} etc., and sub-ranges, such as from about 150° C. to about 250° C., from about 180° C. to about 295° C., etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described, it will be apparent to those skilled in the art that the disclosed examples may be modified. Therefore, the foregoing description is to be considered non-limiting.

1. A structural member, comprising:
a composite structure; and
a filler at least to dampen any of sound wave propagation through the composite structure or vibration of the composite structure, the filler being incorporated into the composite structure and including particles of a shape memory alloy having an Austenite finish temperature (A_{f}) that is lower than a temperature encountered in an application in which the structural member is used so that the shape memory alloy exhibits stress-induced superelasticity.

2. The structural member as defined in claim 1 wherein the composite structure is formed from thermoplastic materials, thermoset materials, toughening agents, or combinations thereof.

3. The structural member as defined in claim 1 wherein the shape memory alloy is chosen from a copper-zinc-aluminum-nickel alloy, a copper-aluminum-nickel alloy, a nickel-titanium alloy, a zinc-copper-gold-iron alloy, a gold-cadmium alloy, an iron-platinum alloy, a titanium-niobium alloy, a gold-copper-zinc alloy, an iron-manganese alloy, a zirconium-cobalt alloy, a zinc-copper alloy, and a titanium-vanadium-palladium alloy.

4. The structural member as defined in claim 1 wherein the composite structure is chosen from an automotive panel structure and an automotive body structure.

5. The structural member as defined in claim 1 wherein the particles of the shape memory alloy are hollow, solid, or combinations thereof.

6. The structural member as defined in claim 5 wherein the particles of the shape memory alloy are spherical, randomly shaped, or combinations thereof.

7. The structural member as defined in claim 5 wherein the particles of the shape memory alloy include a plurality of hollow particles having a distribution of wall thicknesses.

8. The structural member as defined in claim 5 wherein the particles of the shape memory alloy include a plurality of particles having a distribution of sizes.

9. A structural member, comprising:
two members; and
a joint formed between the two members, the joint including:
an adhesive; and
particles of a shape memory alloy incorporated in the adhesive, the shape memory alloy having an Austenite finish temperature (A_{f}) that is lower than a temperature encountered in an application in which the structural member is used so that the shape memory alloy exhibits stress-induced superelasticity.

10. The structural member as defined in claim 9 wherein the two members are automotive panel structures, automotive body structures, or a combination of a panel structure and a body structure.

11. The structural member as defined in claim 9 wherein the shape memory alloy is chosen from copper-zinc-aluminum-nickel alloy, a copper-aluminum-nickel alloy, a nickel-titanium alloy, a zinc-copper-gold-iron alloy, a gold-cadmium alloy, an iron-platinum alloy, a titanium-niobium alloy, a gold-copper-zinc alloy, an iron-manganese alloy, a zirconium-cobalt alloy, a zinc-copper alloy, and a titanium-vanadium-palladium alloy.

12. The structural member as defined in claim 9 wherein the particles of the shape memory alloy are hollow, solid, or combinations thereof.

13. The structural member as defined in claim 9 wherein the particles of the shape memory alloy are spherical, randomly shaped, or combinations thereof.

14. The structural member as defined in claim 9 wherein the particles of the shape memory alloy include:
a plurality of hollow particles having a distribution of wall thicknesses; or
a plurality of particles having a distribution of sizes.

15. A structural member, comprising:
two composite structures; and
particles of a shape memory alloy at least to dampen any of sound wave propagation through the two composite structures or vibration of the two composite structures, the shape memory alloy being disposed between the two composite structures and having an Austenite finish temperature (A_{f}) that is lower than a temperature encountered in an application in which structural member is used so that the shape memory alloy exhibits stress-induced superelasticity.

16. The structural member as defined in claim 15 wherein the two composite structures are automotive panel structures, automotive body structures, or a combination of a panel structure and a body structure.

17. The structural member as defined in claim 15 wherein the shape memory alloy is chosen from copper-zinc-aluminum-nickel alloy, a copper-aluminum-nickel alloy, a nickel-titanium alloy, a zinc-copper-gold-iron alloy, a gold-cadmium alloy, an iron-platinum alloy, a titanium-niobium alloy, a gold-copper-zinc alloy, an iron-manganese alloy, a zirconium-cobalt alloy, a zinc-copper alloy, and a titanium-vanadium-palladium alloy.

18. The structural member as defined in claim 15 wherein the particles of the shape memory alloy are hollow, solid, or combinations thereof.

19. The structural member as defined in claim 15 wherein the particles of the shape memory alloy are spherical, randomly shaped, or combinations thereof.
